(19) United States
(12) Patent Application Publication
(10) Pub. No.: US 2006/0135347 A1
(43) Pub. Date: Jun. 22, 2006

(54) Method for the regeneration of phosphor-laden denox catalysts

(76) Inventors: Alexander Schluttig, Lauta (DE); Marcel Foerster, Oldenburg (DE)

Correspondence Address: MARLANA TITUS, 6005 RIGGS ROAD, LAYTONSVILLE, MD, 20882, US

(21) Appl. No.: 10/527,512

(22) PCT Filed: Sep. 10, 2003
(86) PCT No.: PCT/EP03/10042

§ 371 Date: Jan. 5, 2006

(30) Foreign Application Priority Data
Sep. 11, 2002 (DE) 102 42 081.5

(51) Int. Cl. B01J 38/64

(52) U.S. Cl. 502/25

(57) ABSTRACT

The invention relates to a method for the regeneration of deNOx catalysts with a reduced activity caused by the accumulation of phosphor and phosphorous compounds. The method is characterized in that the catalysts are treated with an essentially aqueous solution of water-soluble alkaline reacting alkaline earth salts, ammonium hydroxide, or alkaline reacting ammonium salts, or water-soluble organic amines with an approximate pK value ranging between 2.5 and 5.5 and that the excess alkali is neutralized by subsequent treatment with inorganic or organic acids.

This application claims priority from PCT/EP/2003/010042, filed Sep. 10, 2003, and German application DE 102 42 081.5, filed Sep. 11, 2002.

### BACKGROUND OF THE INVENTION

The invention relates to a method for the regeneration of phosphorus-loaded denox catalysts.

During the production of current using fossil fuels exhaust gases are obligatorily produced that contain in particular nitrogen oxides and sulfur dioxides in addition to find dust as environmentally harmful compounds. The exhaust gases must therefore be cleaned from these compounds to the extent possible before they can be put into the environment, that is, in other words a desulphurization as well as a denitration and a removal of fine dust by filters are necessary. The desulphurization is carried out according to different methods in which basically the SO₂ produced in the combustion is oxidized to SO₃, then absorbed in alkaline solution and finally removed usually in the form of gypsum. The denitration is carried out parallel to the above during which nitrogen monoxide with ammonia and atmospheric oxygen is converted to elementary nitrogen and water and nitrogen dioxide also reacts with ammonia and atmospheric oxygen to elementary nitrogen and water. This reaction requires catalysts designated as so-called denox catalysts. These are catalysts with various shapes such as with a glass fiber body or honeycomb or plate catalysts, based on titanium dioxide and containing the oxides of various transition metals such a vanadium, molybdenum and tungsten as active components.

The effectiveness of such catalysts decreases after an operating time of, e.g., on the order of 30,000 hours as a function of which fuel is used in the power plant, which is conditioned on the one hand by fly ash settling in and/or clogging the catalyst passages and on the other hand by the formation of blocking layers by the ammonium sulfate formed during the denitration and in addition by a toxification of the active centers by elements or compounds such as, e.g., arsenic, phosphorus, etc.

A special problem is posed by the reduction of performance of denox catalysts by phosphorous compounds. When coal is used as fuel it must be taken into consideration that coal can contain a not insignificant amount of mineral components and that a part of these compounds acts as catalytic poisons such as, e.g., iron, arsenic, phosphorus, thallium, antimony, chromium, etc. The phosphorous content, elementary or in the form of phosphorous pentoxide, can be in a range of approximately 0.5 to 1 wt. % relative to the total amount of mineral components of the coal.

Phosphorous compounds present in the flue gas not only settle mechanically on the surfaces of the catalyst but also enter chemical reactions with the active components and thus result in a reduction of the performance of denox catalysts.

The removal of metals from denox catalysts while retaining structure and activity is described, e.g., in DE 43 00 933 in which method two different gaseous phases are used. However, this method is not suitable for removing other pollutants from the catalyst. All previously known methods for the regeneration of denox catalysts that operate with reaction liquids such as, e.g., EP 0 910 472; U.S. Pat. No. 6,241,826; DE 198 05 295; DE 43 00 933; EP 0 472 853; U.S. Pat. No. 4,914,256 cannot specifically remove phosphorous. That is, in other words, there was previously no possibility of treating catalytic disturbances due to phosphorous.

### SUMMARY OF THE INVENTION

The invention therefore addresses the problem of developing a method that makes possible the specific removal of phosphorous from denox catalysts.

Therefore, in order to solve the problem a method is suggested in which the catalyst is first treated with an aqueous solution of alkali from the group of alkaline earths, ammonium or organic amines and subsequently with an aqueous solution of an inorganic or organic acid.

### DETAILED DESCRIPTION OF THE PREFERRED EMBODIMENTS

A performance of the catalysts can be regained with this method that corresponds to catalysts that are new from the factory or is even greater.

It was surprisingly found that a very extensive elimination of phosphorous compounds is not only possible by the successively occurring action of aqueous alkali and aqueous acid but also that during the course of this treatment even other catalytic poisons are removed such as, e.g., arsenic, thallium, etc.

Since the catalysts to be regenerated originate from different power plants using coal of various origins and qualities as fuel, an analysis of the chemical composition of the catalyst and of its degree of contamination is absolutely necessary prior to carrying out the method. It is readily possible for an expert in the art, using the analysis values and the contents of disturbing phosphorous compounds, to determine the required concentrations of reaction liquid in any previous and subsequent processing steps in advance and to adapt them to the particular situation.

As a rule, catalysts that must be regenerated are heavily loaded with dust so that a mechanical pretreatment for the removal of fly ash from the catalytic surfaces and passages by using industrial vacuum cleaners or compressed air has proven to be usually necessary. For the case in which the catalysts have a thick blocking layer of salts such as ammonium sulfate, produced by the reaction between SO₃ and the so-called ammonia slip, a treatment with water can also take place in order to dissolve these blocking layers.

The catalysts are then placed in a reaction solution substantially representing an aqueous solution of an inorganic or organic base. The use of strong bases for regenerating catalysts such as sodium hydroxide solution or potassium hydroxide solution is known, but it was surprisingly found here that the elimination of phosphorus compounds can best be achieved by using moderately strong bases. Therefore, oxides or hydroxides of alkaline-earth alkali metals or ammonium hydroxide or organic bases with a pH between approximately 2.5 to 5.5 are preferably used. Instead of oxides or hydroxides, alkaline-reacting salts such as carbonates, tartrates, oxalates, acetates, etc. can also be used and the selection of the concretely used compound is determined by its solubility in water and the expense of such a product.

After the treatment with the alkaline reaction solution the catalysts are subjected in a further step to a treatment with acid in order to remove excess alkali and to activate the catalytically active centers of the catalyst. Inorganic acids such as phosphoric acid, sufluric acid or organic acids such as formic acid, acetic acid, chloroacetic acid, citric acid, oxalic acid, tartaric acid or benzene suflonic acid or sulfanylic aicd are preferably used as acids and the selection is again substantially a function of the availability and the expense for such compounds.

Surfactants are preferably added to both solutions in order to to improve the wettability of the catalytic surfaces and the penetration of the reaction liquids into the pores of the catalyst. The addition of anionic, cationic, amphoteric, non-ionic or zwitterionic surfactants is generally in a range between 0.01 to 0.1 wt. % relative to the entire solution.

While the method is being carried out the catalytic module, optionally after mechanical pre-cleaning, is immersed in the reaction solution, in which it can remain for a period of 5 minutes to approximately 24 hours as a function of the degree of contamination and additional treatment. In order to shorten the treatment time the temperature of the solution, that can be in principle between the ambient temperature and higher values up to 100°, should be raised, preferably to approximately 60° C.

Moreover, the treatment time for the alkaline and also for the acidic reaction solution can be shortened and the effectiveness of the treatment increased in that either the catalyst module itself is moved or in that the reaction liquid is regularly moved, which latter can be achieved in a simple manner by agitating mechanisms or wet-pit pumps. If the catalyst is to be moved, this should preferably take place in the longitudinal direction of the conduits in the honeycomb catalyst or in the longitudinal direction of the plates as a lifting movement that can be produced, e.g., in that the module is suspended on a crane and appropriately moved.

The treatment time can be further shortened in that the module is exposed to low-frequency oscillations of the reaction liquids or to ultrasound. The low-frequency range is in the range of 50 to 1000 Hz and the frequency of the ultrasound 10,000 to 100,000 Hz, preferably 20,000 to 50,000 Hz. The treatment with ultrasound results in a local wave movement of the liquid on the catalytic surface and in the formation of cavitations, which favors the dissolution of any blocking layers still present and the dissolution of phosphorous compounds and other compounds from the ceramic material and therewith the freeing of active centers.

A tripartite method proved to be an especially advantageous operating variant in which the catalyst module is subjected to a primary treatment with the alkaline reaction liquid, advantageously during movement of the module or of the surrounding liquid, and advantageously with lifting or agitating movements, and that the module is then transferred into an ultrasonic basin where it is immersed in a reaction liquid of the same composition and sonicated. The contaminated reaction liquid in the first basin can then either be reused or purified by filtration as a function of the degree of contamination.

After the ultrasonic treatment the catalyst module is removed from the sonification basin and immersed in another basin with acidic solution where it is again moved, optionally together with the reaction liquid, that can also be moved. The module is then washed several times with water and finally dried, e.g., by hot air at 50 to 400° C.

Since the transitional metallic oxides functioning as activators and/or active centers are soluble to a certain extent in alkalis as well as in acids, another analysis should be performed at the end of the treatment in order to determine the content of transitional metals. If the discharge during the regeneration resulted in a reduction of the content of transitional metals, a re-impregnation to the desired content can take place immediately by adding an appropriate aqueous solution and by a subsequent drying.

It is possible with the method of the invention to completely regenerate denox catalysts that were reduced in their activity on account of an accumulation of phosphorus compounds and of other metal compounds or metalloid compounds up to an activity corresponding to catalysts that are new from the factory or even somewhat greater. Even a few other metal compounds or metalloid compounds are also removed in the same operating steps by the method of the invention for removing phosphorus impurities.

The invention will be explained in detail using the examples:

### EXAMPLE 1

The catalyst freed of fly ash and with a phosphorus content of 3 g/k is adjusted in a 1.5 n (NH₄)₂ solution with a surfactant addition at a temperature of 20° C. The reaction solution is recirculated in the container with a wet-pit pump. The catalyst remains 15 hours in the container with the reaction solution. After the reaction time has elapsed, the catalyst is removed from the container and treated further.

### EXAMPLE 2

The catalyst freed from fly ash and with a phosphorous content of 5 g/kg is adjusted in a 2.0 n (NH₄)₂ solution with a surfactant addition at a temperature of 60° C. The catalyst remains 0.5 hours in the container with the reaction solution. After the reaction time has elapsed, the catalyst is removed from the container and treated further.

### EXAMPLE 3

The catalyst freed from fly ash is adjusted with a phosphorous content of 5 g/kg in a 2.5 n ammonium carbonate solution with a surfactant addition at a temperature of 20° C. The reaction solution is recirculated in the container with a wet-pit pump. The catalyst remains 15 hours in the container with the reaction solution. After the reaction time has elapsed, the catalyst is removed from the container and treated further.

### EXAMPLE 4

The catalyst module freed from fly ash and with a phosphorous content of 5 g/kg is adjusted in a 2 n calcium acetate solution at a temperature of 60° C. The catalyst is moved in the container by a lifting mechanism. An ultrasonic treatment with an energy density of 3 W/l takes place at the same time. The catalyst remains 0.3 hours in the container with the reaction solution. After the reaction time has elapsed, the catalyst is removed from the container, washed several times with water, preferably as a cascade wash, and subsequently dried with hot air.

### EXAMPLE 5

The catalyst module freed from fly ash and with a phosphorous content of 5 g/kg is adjusted in a saturated calcium hydroxide solution at a temperature of 60° C. The catalyst is moved in the container by a lifting mechanism. An ultrasonic treatment with an energy density of 3 W/l takes place at the same time. The catalyst remains 0.3 hours in the container with the reaction solution. After the reaction time has elapsed, the catalyst modules are removed from the reaction basis and immersed in an aqueous neutralization bath containing oxalic acid. The catalyst remains 2 hours in this neutralization solution. The catalyst is subsequently washed several times with water, preferably as a cascade wash, and subsequently dried with hot air.

### EXAMPLE 6

The catalyst module freed from fly ash and with a phosphorous content of 5 g/kg is adjusted in a 2 n ammonium carbonate solution at a temperature of 20° C. The catalyst remains 15 hours in the reaction solution. The reaction solution is recirculated in the container with a wet-pit pump. The catalyst is subsequently adjusted in a 2 n ammonium carbonate solution at a temperature of 60° C. The catalyst is moved in the container by a lifting mechanism. An ultrasonic treatment with an energy density of 3 W/l takes place at the same time. The catalyst remains 0.3 hours in the container with the reaction solution. After the reaction time has elapsed, the catalyst modules are removed from the reaction basis and immersed in an aqueous neutralization bath containing oxalic acid. The catalyst remains 2 hours in this neutralization solution. The catalyst is subsequently washed several times with water, preferably as a cascade wash, and subsequently dried with hot air. After the drying the catalyst is placed in an aqueous solution of a vanadium salt containing 6.75 g/l vanadium at a temperature of 20° C., where it remains 0.5 hour. The catalyst is subsequently dried with hot air.

1-15. (canceled)

16. A method for the regeneration of denox catalysts with reduced activity based on the accumulation of phosphorous and phosphorous compounds, comprising the steps of:
(i) treating the catalysts with a substantially aqueous solution of water-soluble, alkalinely reacting alkaline earth salts, ammonium hydroxide or alkalinely reacting ammonium salts or water-soluble organic amines with a pH between approximately 2.5 and 5.5,
(ii) neutralizing excess alkali by a subsequent treatment with inorganic or organic acids, and
(iii) treating the catalyst with an ultrasonic treatment or treating the catalyst with low-frequency oscillations in the reaction solution, so that regeneration of the denox catalysts is effected.

17. The method according to claim 16, wherein the water-soluble alkalinely reacting alkaline earth salts, ammonium hydroxide or alkalinely reacting ammonium salts or water-soluble organic amines alkaline earth hydroxides or water-soluble salts are selected from the group consisting of acetates, carbonates or oxalates, ammonium acetate, ammonium carbonate, ammonium oxalate or amines, and methyl amines.

18. The method according to claim 16, which comprises the further step of, following step (i), neutralizing the remaining alkali by forming water-soluble salts of organic or inorganic acids.

19. The method of claim 18, wherein the water-soluble salts of organic or inorganic acids are selected from the group consisting of phosphoric acid, sulfuric acid, oxalic acid, citric acid, malonic acid, formic acid, acetic acid, tartaric acid, chloroacetic acid, benzene suflonic acid and sulfanylic acid.

20. The method according to claim 16, which comprises the further step of adding anionic, cationic, amphoteric, non-ionic or zwitterionic surfactants are added to the alkaline treatment solution of step (i) and to the acidic treatment solution of step (ii).

21. The method according to claim 20, wherein the surfactants are used in amounts betweem 0.01 to 0.1 weight percent.

22. The method according to claim 16, wherein step (i) takes place at temperatures ranging between room temperature to 100° C.

23. The method according to claim 16, which comprises the further step or steps of moving the catalyst in the reaction solution of step (i) during the exposure time, and/or maintaining the acidic or alkaline reaction solutions in movement.

24. The method according to claim 23, wherein the catalyst is moved by lifting and/or the reaction solutions are maintained in movement by agitation or recirculation.

25. The method according to claim 16, wherein the low-frequency oscillations are used with 20 to 1000 Hz and ultrasound is used with 10,000 to 100,000 Hz.

26. The method according to claim 25, wherein the ultrasound is used with from approximately 20,000 to 50,000 Hz.

27. The method according to claim 16, wherein step (i) and the ultrasonic treatment of step (iii) are carried out successively in separate basins.

28. The method according to claim 16, which comprises the further step or steps of subjecting the catalyst to a mechanical pretreatment to remove fine dust, and/or subjecting the catalyst to a pretreatment with water.

29. The method according to claim 16, which comprises the further step after step (ii) of washing the catalyst with water and drying the catalyst.

30. The method according to claim 29, which comprises the further step after washing the catalyst with water and drying the catalyst, of re-impregnating the activator elements with water-soluble compounds.
